(19) United States
(12) Patent Application Publication
(10) Pub. No.: US 2010/0235567 A1
(43) Pub. Date: Sep. 16, 2010

(54) AIRCRAFT INCLUDING DATA DESTRUCTION MEANS

(75) Inventors: Marc PERROUD, Saint-Genies-Bellevue (FR); Miguel ESTRADA-FERNANDEZ, Fonsorbes (FR)

Correspondence Address: OLIFF & BERRIDGE, PLC, P.O. BOX 320850, ALEXANDRIA, VA, 22320-4850, US

(73) Assignee: AIRBUS OPERATIONS, Toulouse (FR)

(21) Appl. No.: 12/718,676

(22) Filed: Mar. 5, 2010

(30) Foreign Application Priority Data
Mar. 13, 2009 (FR) 0951605

(51) Int. Cl. G06F 12/02; F42B 4/00; G06F 12/14

(52) U.S. Cl. 711/103; 102/335; 711/166; 711/165; 340/973; 711/E12.008; 711/E12.002; 711/E12.091

(57) ABSTRACT

The aircraft includes:
means for causing data of a predetermined type to be stored on board solely in one or more memories; and
automatic means for acting, when a predetermined event occurs, to destroy the data stored in this way.

### FIELD OF THE INVENTION

The invention relates to aircraft and in particular to destroying data on board aircraft.

### BACKGROUND OF THE INVENTION

Military aircraft may have sensitive data on board such as mission flight plans, ciphering and deciphering keys for communications, etc. For obvious reasons, such data must not be recovered by an enemy.

However, in the event of an aircraft crashing or being intercepted in enemy territory, the confidentiality of the on-board data is not guaranteed. It might therefore be possible for the enemy to recover said data and use it for military purposes, and that is not acceptable.

Furthermore, removal of on-board equipment by a maintenance operator also raises questions of data protection. If the equipment contains sensitive data, it runs the risk of being disseminated, in particular if the equipment is removed from the aircraft. When the equipment is sent to a repair shop of the maintenance operator, the equipment and thus the data it contains remain theoretically under the control of the operator. That reduces the risk of the data being disseminated. However that solution raises difficulties when maintenance is subcontracted. And in the event of the equipment being sent to a supplier, e.g. for repair, the question of dissemination remains in full.

### OBJECT AND SUMMARY OF THE INVENTION

An object of the invention is to reinforce the protection of on-board data, in particular sensitive data.

To this end, the invention provides an aircraft that includes:
means for causing data of a predetermined type to be stored on board solely in one or more memories; and
automatic means for acting, when a predetermined event occurs, to destroy the data stored in this way.

Thus, the destruction of the data in the or each memory containing it prevents the data from being transmitted to the enemy even if the memories fall into enemy hands. This reduces the risk of malevolent use of the data. Similarly, an internal or external operator can take action on the memory without any risk of the data being disseminated.

Advantageously, the aircraft includes at least one of the following members suitable for signaling the occurrence of the predetermined event:
a moisture sensor;
temperature sensor;
an accelerometer or impact sensor;
an inertial relay or sensor;
a manual control member;
a geographical positioning member;
an altimeter;
an on-board computer;
a discrete input;
a radio receiver;
a sensor for sensing removal of the memory or one of the memories; and
a sensor for sensing ejection of a pilot or a command for such ejection.

Preferably, the memory or one of the memories is a volatile memory.

This memory has the advantage that its content can be erased in secure manner as a result of it no longer being powered electrically. This erasure takes place quickly, since it requires only a few milliseconds. Furthermore, it is reliable insofar as the information erased in this way cannot be recovered, unlike that which can be done with other types of memory. The erasure is actual physical erasure and not mere logical erasure in which the data remains present in the memory.

Advantageously, the aircraft includes means for maintaining the memory or one of the memories under power whenever the or each main electricity power supply network of the aircraft is off.

This simplifies the management of on-board data. Even when the main network(s) of the aircraft is/are off, the data remains present in the memory and there is no need to transfer it onto another medium before switching off the aircraft.

Preferably, data destruction comprises switching the memory off.

This ensures that the data is destroyed simply and quickly.

Preferably, the memory or one of the memories is a flash memory.

Unlike a volatile type memory, this memory conserves data even when it is off. It is therefore possible to conserve the data on board in the memory even when all of the systems of the aircraft are turned off. This embodiment is thus more appropriate for certain uses.

Advantageously, the means are suitable for causing the data to be destroyed in at least one of the following modes:
erasing the data;
igniting a pyrotechnic charge;
chemical attack; and
subjecting the memory to an overvoltage.

Preferably, the memory is a main memory and the aircraft includes an auxiliary memory and means for causing data to be copied from the main memory to the auxiliary memory in the presence of a second predetermined event.

Thus, in particular in the context of the main memory being disassembled or removed from the aircraft, the data is backed up on the auxiliary memory. Data integrity is thus preserved while preventing the data being disseminated in a maintenance context.

The invention also provides a method of protecting data on board an aircraft, the method comprising the steps of:
storing data of a predetermined type on board solely in one or more memories; and
when a predetermined event occurs, automatically commanding destruction of the data as stored in this way.

The invention also provides a computer program that includes code instructions suitable for commanding the implementation of the steps of a method of the invention when executed on a computer.

The invention also provides a data recording medium that contains a program of the invention in recorded form.

Finally, the invention provides making a program of the invention available on a telecommunications network for downloading.

### BRIEF DESCRIPTION OF THE DRAWINGS

Other characteristics and advantages of the invention appear further from the following description of two embodiments given as non-limiting examples with reference to the accompanying drawings, in which:

FIG. 1 is a front view of an airplane in an embodiment of the invention;

FIG. 2 is a diagram of a device for implementing the invention on board the FIG. 1 airplane;

FIGS. 3, 4, and 5 are flow charts showing the implementation of the method of the invention on board the FIG. 1 airplane; and

FIGS. 6, 7, and 8 are views analogous respectively to FIGS. 2, 4, and 5 showing a second embodiment of the invention.

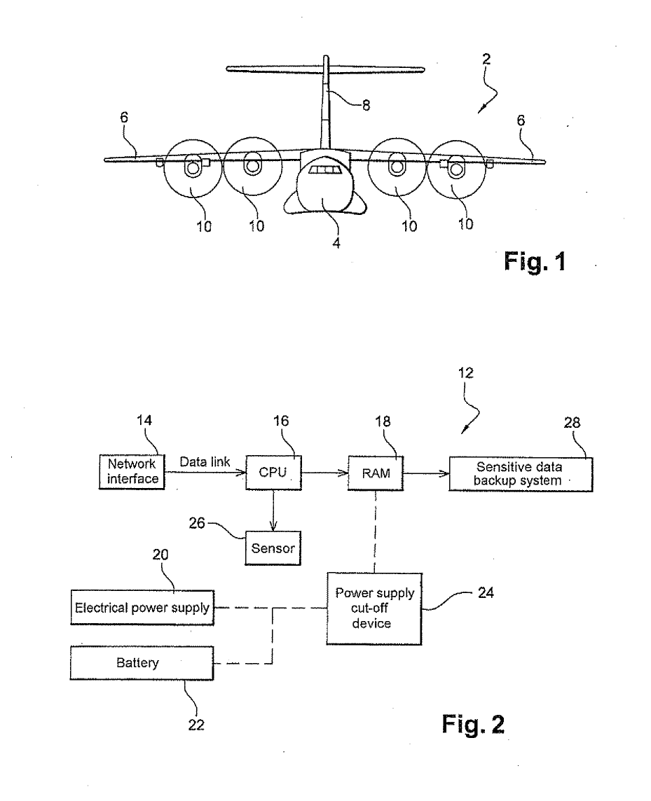

### MORE DETAILED DESCRIPTION

The invention is applicable to any type of land, sea, air, or space vehicle. It applies equally well to wheeled vehicles and to vehicles that fly or that travel on or under water.

In the present example, the aircraft 2 of the invention is an aerodyne such as an airplane. The airplane 2 of FIG. 2 specifically comprises a fuselage 4, two wings 6, a tail fin 8, and engines 10. Specifically, the engines are propeller thrusters and there are four of them. In the present example, the airplane 2 is for military use, but the invention is equally applicable to airplanes for civil use.

The invention relates to the information systems on board the airplane. It seeks to guarantee the confidentiality of sensitive on-board data by proceeding, if necessary, to erase the data security. The purpose is specifically to protect so-called “sensitive” data such as data that would give malevolent persons a substantial advantage if they were to possess it. As explained for the first embodiment, the invention makes it possible to achieve secure erasure of on-board data in a very short time lapse.

The invention is implemented on board by means of the system 12 shown in FIG. 2 in a first embodiment. The system is in communication with other known systems conventionally to be found on board (piloting system, navigation system, etc.). The system 12 comprises a network interface device 14 via which it can communicate with said other systems or with telecommunications networks external to the airplane.

The system 12 comprises a central processor unit (CPU) 16.

The system comprises a storage device or memory 18 suitable for receiving data and conserving it in recorded form for playback. In this example the memory is a random access memory (RAM). Specifically, it is a read-write memory, or indeed a volatile memory. In particular, it may be a so-called “static” read-write memory or it may be a read-write memory of the dynamic type.

Such a memory 18 stores data in recorded form only so long as it is powered, i.e. so long as it is supplied with electricity. An electrical power supply 20 is thus provided that is connected firstly to the main on-board power supply network (or to one of them if there are several) and secondly to the memory in order to supply it with electricity. When the on-board electricity network(s) of the airplane is/are off, the memory 18 is powered from a battery 22 of the system 12 that enables the memory 18 to be maintained under power.

Thus, when the on-board electricity network(s) is/are active, the power supply 20 powers the memory 18, thereby conserving the data. When the airplane is off and the on-board electricity networks are no longer powered, a voltage is maintained across the terminals of the memory by means of the battery 22.

The system 12 serves in particular to collect and host sensitive data without that data being hosted elsewhere on board the airplane. In this embodiment, the systems on board the airplane, and in particular the CPU 16, are arranged to cause the sensitive data to be stored on board solely in the volatile memory.

The data is loaded into the memory from the network interface 14 by passing through the CPU 16. The CPU is connected firstly to the network interface 14 and secondly to the memory 18 so as to exchange data with both of these two elements.

The system 12 also has a device 24 for cutting off the electrical power supply to the memory 18. This device is interposed between firstly the electrical power supply 20 and the battery 22, and secondly the memory. It may be constituted by a relay, for example.

The system 12 also has at least one member 26 such as a sensor that serves to inform the CPU 16 that a predetermined event has occurred.

In the present example, numerous members are connected to the CPU 16, each for the purpose of detecting the occurrence of a predetermined event. These members are the following:
a moisture sensor for detecting that the aircraft has alighted on the sea;
a temperature sensor that serves to identify that there is a fire on board;
an accelerometer that serves to detect that the airplane is falling or that acts as an impact sensor and enables a collision of the airplane to be recognized;
one or more inertial relays or sensors;
an on-board manual control member such as a pushbutton: this member enables an on-board operator, e.g. a pilot in the cockpit, to manually command erasure of the data in the memory 18;
a geographical positioning member such as a global positioning system (GSP) sensor: this serves to detect that the airplane has entered a particular zone or has left a particular zone;
an altimeter: this serves to detect that the altitude of the airplane has crossed a predetermined threshold and thus to inform that the altitude is too high or too low relative to circumstances;
an on-board computer: this serves to send a data stream to the CPU 16 via the on-board network, this stream possibly including an order to erase the memory 18;
a discrete input, i.e. a wire connected to a predetermined member of the airplane and capable of taking a “0” state or a “1” state depending on circumstances;
a radio receiver enabling an order to be transmitted to the CPU 16 to erase the data in the memory 18, which order is transmitted from outside the airplane, e.g. via a satellite;
a sensor for sensing removal of the memory 18: this sensor serves to detect that the device constituting the memory 18 has been taken out of its housing, e.g. taken from its rack in the avionics bay. It is thus possible to trigger erasure of sensitive data when the memory is extracted from its rack, e.g. for a maintenance operation; and
a sensor for sensing that a pilot has ejected from the airplane or for detecting an ejection command: when the pilot ejects, the data is deleted.

Specifically, the accelerometer is a member that acts under all circumstances to provide a measurement of acceleration or deceleration for processing by control electronics, whereas the inertial sensor is of a mechanical nature and detects when a trigger threshold has been crossed.

This list is not exhaustive and other types of member may be used in other embodiments to identify predetermined events that, should they occur, are to trigger an order for the CPU 16 to erase the data. Conversely, it is possible to retain only one or only a few of the listed members.

For at least some of these sensors, it is possible to define a threshold value such that if a magnitude delivered by the sensor crosses the threshold (upwards or downwards as the case may be), then the CPU 16 considers that the predetermined event has occurred.

Thus, when one of the sensors provides a magnitude that exceeds a predetermined threshold, the device 24 is activated so that the electrical power supply to the memory 18 is cut off. Thus, the data it contains is erased in safe and reliable manner. That is because it is not possible, a posteriori, to recover the data that was initially present in a volatile memory.

The system 12 also has a member 28 for backing up the data present in the memory 18 under particular circumstances, e.g. when some other predetermined event occurs. For this purpose, the member 28 is connected appropriately to the memory 18 and itself includes a memory.

The device 28 constitutes an external medium and serves to back up the data under various circumstances.

This applies for example when the battery 22 is about to become no longer available while the main electrical power supply networks of the airplane are off.

This may also occur in the event of very low on-board temperature, e.g. when the temperature drops below −15° C.

This also occurs when the on-board electricity network is switched off for a very long period, such that the battery 22 can no longer be recharged from the network, as it is usually and frequently.

Thus, the device 28 serves to receive the data present in the memory 18 when the memory is to be removed for maintenance purposes and the data needs to be erased therefrom. This recovery of the data may be designed to be triggered manually by an operator. It is also possible to make provision for recovery to be automatic when an event of a predetermined type is detected.

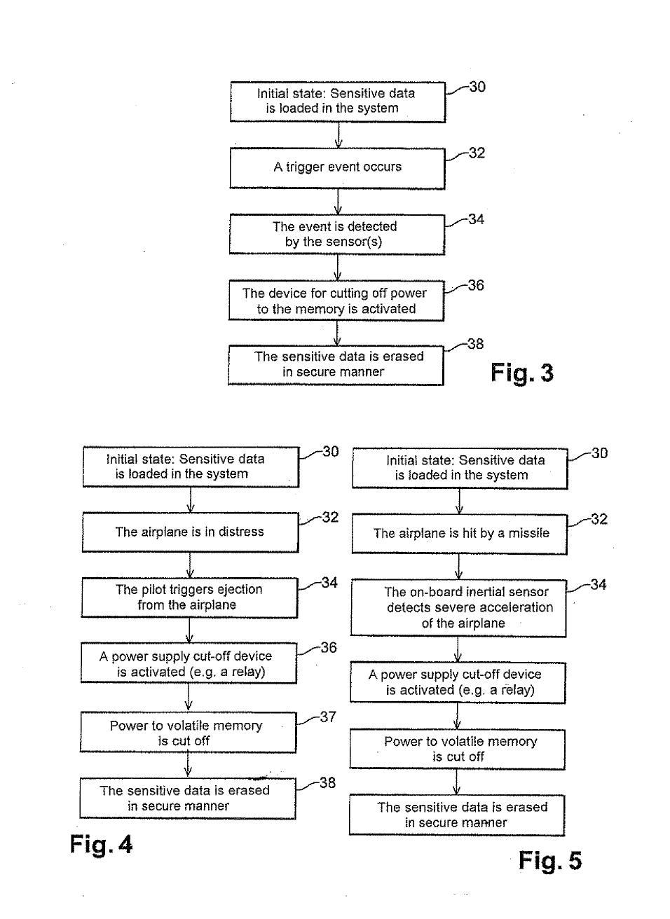

The steps for implementing the method of the invention are shown in FIG. 3 for the general sequence.

It is assumed that the method begins with an initial step 30 in which sensitive data is loaded into the memory 18.

In the following step 32, one of the events of the predetermined type occurs.

In the following step 34, the sensor associated with this type of event detects its occurrence.

In the following step 36, the CPU 16, as informed by the sensor for sensing the occurrence of the event, commands the electrical power supply to be cut off by the device 24.

Thus, in the following step 38, the sensitive data in the memory 16 is erased in secure manner.

A more specific example of this sequence is shown in FIG. 4. Here it is specified in step 32 that the predetermined event is that the airplane is in distress.

In step 34, the pilot triggers ejection from the aircraft and this triggering is detected by the associated sensor 26. Steps 36 and 38 are unchanged. Step 37 is shown, consisting in cutting off the power supply to the volatile memory.

Another specific example is shown in FIG. 5. It is similar to the example of FIG. 4. This time, in step 32, the airplane is hit by a missile. In step 34, it is an on-board inertial sensor that detects a severe crash of the airplane. For example, the inertial detector detects an acceleration along the vertical axis of the airplane greater than 10 g. The other steps remain unchanged.

It should be observed that once the data erasure process has been triggered, it is impossible to stop it so the data is necessarily erased in complete and secure manner. This embodiment enables data to be erased even in the event of the system containing the sensitive data being degraded, e.g. in the event of an impact or alighting on the sea.

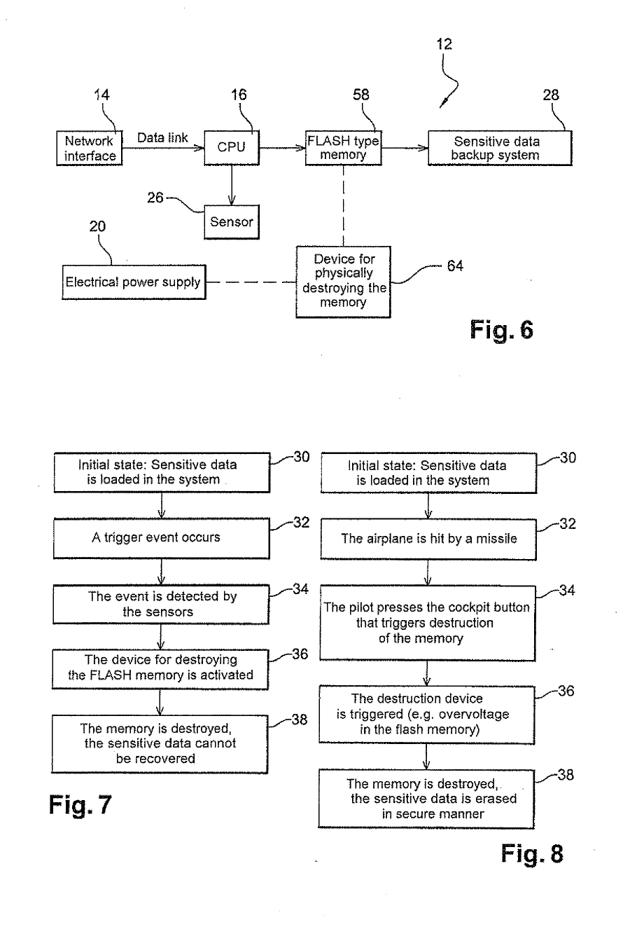

FIG. 6 shows a second embodiment of the invention. It differs from the embodiment of FIG. 2 by the fact that the memory 58 in this embodiment is of the flash type. This is a rewritable semiconductor mass memory. This memory has random access and the characteristics of a read-write memory, but the data does not disappear when it is switched off.

That is why the battery 22 is omitted from the system 12 shown in FIG. 6. For the same reasons, the electrical power supply cut-off device can no longer be used with this memory, so it is replaced by a data destruction device. This device may be designed to perform destruction in at least one of the following modes:
erasure of the data;
igniting a pyrotechnic charge (such as a microcharge) that destroys the memory;
a chemical attack that destroys the memory; and
subjecting the memory to an overvoltage.

In the diagram of FIG. 6, the device ensures that the memory is physically destroyed. It may thus be a trigger device, a chemical attack device, or means for generating an overvoltage.

The method is implemented in a manner analogous to that described above with reference to the above embodiment. Thus, FIG. 7 shows the general sequence of the method. This sequence is identical to that of FIG. 3, except that step 36 this time consists in activating the device for destroying the data in the flash memory.

In the example of FIG. 8, there is shown the situation in which, in step 32, the airplane is hit by a missile, and in which, in step 34, the pilot presses on a pushbutton in the cockpit to trigger destruction of the memory. In step 36, the memory destruction device acts, e.g. by producing an overvoltage across the terminals of the memory, thereby destroying it. In step 38, the memory is destroyed and the sensitive data is thus erased in secure manner.

Preferably, the system 12 is given sufficient resources to enable it to destroy the data in independent manner. Thus, the electrical power supply 20 may be replaced by or associated with a conventional battery or indeed by a battery of capacitors. Providing such independent power supply means for the device that physically destroys the memory, said means being independent of the power supply network 20 of the airplane, makes it possible for destruction of the memory to be accomplished even when the network is out of operation.

In these two embodiments, implementation of the method is controlled by the CPU 16 by means of a computer program including code instructions suitable for controlling the execution of the method when executed on the CPU. The program may be recorded on a fixed or removable recording medium such as a hard disk, a flash memory, a compact disk (CD) or a digital video disk (DVD), etc. Provision may also be made for the program to be available on a telecommunications network for downloading. This program, together with other programs used by the CPU 16 may be stored in the memory 18 or 58, or in a memory of the system that is not designed to receive sensitive data.

Naturally, numerous modifications may be made to the invention without going beyond the ambit thereof.

It is possible to use a memory of a type other than a volatile memory or a flash memory. Nowadays, there are two major types of memory for storing data:
mass memories (of the read-only memory (ROM), hard disk, flash memory type); and
volatile memories or RAM.

When data is erased in conventional manner from a mass memory, the data is erased without the physical data being overwritten. That leaves the information easy to recover. With that kind of erasure, the information can no longer be consulted directly, but it is still present in the mass memory.

It is also possible to perform erasure by overwriting the data once. For this purpose, random data is written over the data that is to be overwritten. Such erasure is much more reliable and acceptable on a system. Nevertheless, it has the drawback of taking a relatively long time. Furthermore, with sophisticated equipment such as an electron microscope, it is still possible to find the information that is supposed to have been destroyed by being overwritten. Such uncertainty is unacceptable in certain domains, in particular in the military domain.

Finally, another technique consists in overwriting the data multiple times. This is done by writing random data several times over on the data to be erased in the mass memory. This technique has the drawback of being lengthy to implement and incompatible with an on-board military system in which it is desired to erase the data urgently, e.g. in the event of the aircraft crashing. Nevertheless, this technique is very reliable since it makes it impossible to recover the data.

Furthermore, without departing from the invention, it is possible to make provision for using an aircraft that includes:
at least one volatile memory; and
means for keeping the memory powered while the or each main electricity power supply network of the airplane is off.

Similarly, without departing from the invention, provision may be made to use a method of protecting data on board an aircraft, in which method data of a predetermined type is stored solely in a volatile memory.

Provision may be made for the system 12 to have a plurality of memories for storing sensitive data. It is then possible to make provision for each data item to be stored in a plurality of said memories or on the contrary in a single one of them, and for the data to be shared between the memories. The essential point is to destroy all of the data in all of the memories in the presence of the predetermined event.

1. An aircraft comprising:
means for causing data of a predetermined type to be stored on board solely in one or more memories; and
automatic means for acting, when a predetermined event occurs, to destroy the data stored in this way.

2. An aircraft according to claim 1, including at least one of the following members suitable for signaling the occurrence of the predetermined event:
a moisture sensor;
a temperature sensor;
an accelerometer;
an inertial relay or sensor;
a manual control member;
a geographical positioning member;
an altimeter;
an on-board computer;
a discrete input;
a radio receiver;
a sensor for sensing removal of the memory or one of the memories; and
a sensor for sensing ejection of a pilot or a command for such ejection.

3. An aircraft according to claim 1, wherein the memory or one of the memories is a volatile memory.

4. An aircraft according to claim 3 including means for maintaining the memory or one of the memories under power whenever the or each main electricity power supply network of the aircraft is off.

5. An aircraft according to claim 3, wherein destruction comprises switching the memory off.

6. An aircraft according to claim 1, wherein the memory or one of the memories is a flash memory.

7. An aircraft according to claim 1, wherein the means are suitable for causing the data to be destroyed in at least one of the following modes:
erasing the data;
igniting a pyrotechnic charge;
chemical attack; and
subjecting the memory to an overvoltage.

8. An aircraft according to claim 1, wherein the memory is a main memory and the aircraft includes an auxiliary memory and means for causing data to be copied from the main memory to the auxiliary memory in the presence of a second predetermined event.

9. A method of protecting data on board an aircraft, the method comprising:
storing data of a predetermined type on board solely in one or more volatile memories;
maintaining the or each memory under power whenever the or each main electricity power supply network of the airplane is off; and
when a predetermined event occurs, automatically commanding destruction of the data as stored in this way.

10. A computer program, including code instructions suitable for commanding the implementation of steps of a method according to claim 9 when executed on a computer.
